(19) United States
(12) Patent Application Publication
(10) Pub. No.: US 2026/0346394 A1
(43) Pub. Date: Nov. 5, 2026

(54) POWER TOOL

(71) Applicant: JIANGSU DONGCHENG M&E TOOLS CO., LTD., NANTONG (CN)

(72) Inventors: JIAN SU, NANTONG (CN); DE LUO, NANTONG (CN); SIHAO YANG, NANTONG (CN)

(21) Appl. No.: 19/724,905

(22) Filed: Jun. 30, 2026

Related U.S. Application Data
(63) Continuation of application No. PCT/CN2026/078572, filed on Feb. 11, 2026.

(30) Foreign Application Priority Data
Dec. 13, 2024 (CN) 202423089913.3
Jan. 7, 2025 (CN) 202510023539.7

(51) Int. Cl. B24B 23/02; B25F 5/00; B25F 5/02

(52) U.S. Cl. CPC B24B 23/02; B25F 5/001; B25F 5/008; B25F 5/02

(57) ABSTRACT

A power tool includes: a housing, a motor assembly mounted within the housing, a switch assembly for controlling the motor assembly, a transmission assembly coupled to the motor assembly, and an output member coupled to the transmission assembly. The housing includes a first housing configured to accommodates the motor assembly, a second housing configured to accommodates the transmission assembly, and a mounting base configured to receive a battery pack. The mounting base is provided with an insertion slot. The insertion slot has an opening through which the battery pack is mounted into the mounting base and a bottom opposing the opening. An extension direction of the insertion slot is inclined at an angle of less than 90 degrees relative to an axis of the motor assembly. The power tool can enhance or improve the user's operational experience and comfort degree.

### CROSS REFERENCE TO RELATED APPLICATIONS

The present application is a continuation of PCT patent application PCT/CN 2026/078572, entitled “POWER TOOL,” filed on Feb. 11, 2026, which claims the benefit of priority to Chinese patent application No. 202423089913.3, filed on Dec. 13, 2024, and to Chinese patent application No. 202510023539.7, filed on Jan. 7, 2025, each of which is incorporated herein by reference in its entirety.

### TECHNICAL FIELD

Embodiments of the present disclosure relate to the technical field of power tools, and in particular, to a power tool used in occasions such as decoration and construction.

### BACKGROUND

Power tools, especially those powered by direct current (DC), typically utilize a battery pack to supply power, which drives a motor to operate and further actuates an end tool for work. In related technologies, the housing of a DC tool includes a motor housing that accommodates the motor, a handle portion for the user to hold, and a battery mounting portion for mounting/removing the battery pack by sliding. The handle portion is connected to the motor housing, and the battery mounting portion is connected to the handle portion.

Moreover, the user's experience in operating the tool may vary depending on the tool's construction. Factors such as the size of the tool housing, the disposing position of the motor, and the insertion direction of the battery pack may all affect the user's operation experience. An unreasonable tool structure often impairs operational comfort and reduces work efficiency, making it difficult to gain user preference.

In view of this, there is indeed a need to provide an improved power tool to overcome the deficiencies existing in the related technologies.

### SUMMARY

To address the deficiencies in the related technologies, the objective of the present disclosure is to provide an ergonomic power tool aimed at enhancing or improving the user's operational experience and comfort degree when using the tool.

To solve the technical problems of the related technologies, the present disclosure may adopt the following technical solution. A power tool includes a housing, a motor assembly mounted within the housing, a switch assembly for controlling the motor assembly, a transmission assembly coupled to the motor assembly, and an output member coupled to the transmission assembly. The motor assembly is configured to drive the output member to rotate. The housing includes a first housing configured to accommodates the motor assembly, a second housing configured to accommodates the transmission assembly, and a mounting base configured to receive a battery pack. The first housing has a handle portion for a user to hold. The second housing is located at a front end of the first housing, and the mounting base is located at a rear end of the first housing. The mounting base is provided with an insertion slot. The insertion slot has an opening through which the battery pack is mounted into the mounting base and a bottom opposing the opening. The opening is located on a side of the insertion slot away from the output member. An extension direction of the insertion slot is inclined at an angle of less than 90 degrees relative to an axis of the motor assembly. The extension direction of the insertion slot refers to a direction from the opening of the insertion slot toward the bottom of the insertion slot.

In some embodiments, the switch assembly includes a switch element electrically connected to the motor assembly and a switch trigger for actuating the switch element. The mounting base has a first end and a second end opposing the first end. The first end is closer to the output member than the second end. The second housing is provided with a protrusion adjacent to the switch trigger. The first end and the protrusion together define an accommodation space, and the switch trigger is accommodated in the accommodation space.

In some embodiments, the mounting base has an inclined surface, that is inclined relative to the axis of the motor assembly. A curved transition is provided between the inclined surface and the first housing.

In some embodiments, the motor assembly is coaxial with the output member and the transmission assembly.

In some embodiments, the angle included between the insertion slot and the axis of the motor assembly ranges from 50 degrees to 70 degrees.

In some embodiments, a diameter of the handle portion is smaller than a diameter of the second housing, and the switch assembly is mounted within the first housing.

In some embodiments, the diameter of the handle portion ranges from 120 mm to 180 mm.

In some embodiments, the power tool includes a controller assembly connected to the switch assembly. The switch element of the switch assembly is disposed between the controller assembly and the motor assembly. The controller assembly is housed within the mounting base. The controller assembly includes a controller board that is inclined relative to the axis of the motor assembly.

In some embodiments, the power tool includes wires connecting the motor assembly, the switch assembly, and the controller assembly to each other. A wiring channel is defined on the switch element, and at least a portion of the wires are routed through the wiring channel.

In some embodiments, the motor assembly includes a stator and a rotor connected to each other, as well as a fan driven by the rotor. The fan is disposed between the stator and the transmission assembly. The housing is provided with an air inlet and an air outlet, with the air inlet being defined adjacent to the controller assembly and the air outlet being defined adjacent to the fan. The fan is a centrifugal fan.

In some embodiments, the motor assembly includes a first bearing and a second bearing supporting on two sides of a rotor shaft of the rotor. The stator and the fan are disposed between the first bearing and the second bearing, and the rotor shaft is extended into the second housing. The first bearing is disposed within the first housing, and the second bearing is disposed within the second housing.

In some embodiments, the power tool has a first gear stage and a second gear stage. In the first gear stage, a transmission ratio of the power tool is 1:5, and in the second gear stage, the transmission ratio of the power tool is 1:15.

In some embodiments, In the first gear stage, an output rotational speed of the power tool ranges from 2700 r/min to 3300 r/min. In the second gear stage, the output rotational speed of the power tool ranges from 900 r/min to 1100 r/min.

The present disclosure may also adopt the following technical solution to address the problems in the related technologies. A power tool includes a housing, a motor assembly mounted within the housing, a gearbox coupled to a front end of the motor assembly, a controller assembly coupled to a rear end of the motor assembly, and an output member driven by the gearbox. The motor assembly has an axis passing through the controller assembly, the gearbox, and the output member. The housing includes a first housing configured to accommodate the motor assembly, a second housing configured to accommodate the gearbox, and a mounting base configured to receive a battery pack. The controller assembly is installed inside the mounting base. The mounting base is provided with an insertion slot for mounting the battery pack, and the insertion slot is inclined at an angle of less than 90 degrees relative to the axis of the motor assembly. The housing is further provided with a gear shifter configured to shift gear stages of the power tool and a switch trigger configured to control start and stop of the motor assembly. The gear shifter and the switch trigger are respectively disposed on opposing sides of the gearbox.

In some embodiments, the mounting base has a first end and a second end opposing the first end. The first end is closer to the output member than the second end. The second housing is provided with a protrusion adjacent to the switch trigger. The first end and the protrusion together define an accommodation space, and the switch trigger is accommodated in the accommodation space.

In some embodiments, the controller assembly includes a controller board, that is inclined relative to the axis of the motor assembly.

In some embodiments, the power tool further includes a switch assembly for controlling the motor assembly. The switch assembly includes a switch element electrically connected to the motor assembly, a switch trigger for actuating the switch element, and a lock-off switch mounted to the switch trigger. The switch trigger is at least partially exposed outside the housing, and the switch trigger is a rod trigger. An end of the switch trigger is pivotally mounted to the housing, and the lock-off switch is disposed on an opposing side of the end of the switch trigger.

In some embodiments, the power tool includes an engagement portion configured to engage with the lock-off switch. The engagement portion includes an engagement surface in contact with the lock-off switch, the lock-off switch includes a pivot shaft and a connecting arm extending from the pivot shaft toward the engagement portion, and the connecting arm is arranged to be inclined relative to the engagement surface.

In some embodiments, the lock-off switch has a first position in which the switch trigger is restricted from moving relative to the switch element and a second position in which the switch trigger is free to move relative to the switch element, and in the first position, an end of the lock-off switch abuts against the engagement surface.

In some embodiments, the lock-off switch includes an actuation portion extending from the pivot shaft away from the engagement portion, and the connecting arm is in contact with the engagement surface.

Compared with the related technologies, the present disclosure offers the following advantageous effects. An included angle between an extension direction of the insertion slot and the axis of the motor assembly less than 90 degrees allows the battery pack to be mounted in an inclined way relative to the axis of the motor assembly. Thus, the space occupied by the battery pack in the up-down direction can be reduced, thereby minimizing the interference of the battery pack with the user's arm during operation of the power tool and significantly improving the user's experience and comfort degree. Furthermore, a surface of the mounting base adjacent to the handle portion is formed as an inclined surface relative to the axis of the motor assembly, which reduces the space occupied by the mounting base in the up-down direction. This configuration also decreases the likelihood of the interference of the mounting base with the user's arm, making operation more comfortable and enhancing ergonomic compatibility. The switch element is provided with a through wiring channel through which at least a portion of the wires are routed. This arrangement results in a cleaner and more organized wire layout, facilitating easier wiring. Additionally, the angle between the light-guiding surface and the axis of the motor assembly is set in a range from 35 to 60 degrees, which optimizes the lighting effectiveness of the illumination assembly.

### BRIEF DESCRIPTION OF THE DRAWINGS

FIG. 1 is a schematic view of a power tool according to some embodiments of the present disclosure;

FIG. 2 is an exploded view of the power tool shown in FIG. 1;

FIG. 3 is a schematic view showing the internal structure of the power tool shown in FIG. 1;

FIG. 4 is a cross-sectional view of the power tool shown in FIG. 1;

FIG. 5 is an enlarged view of the area D circled in FIG. 2;

FIG. 6 is a schematic view showing the power tool of FIG. 1 with a battery pack placed on a flat surface;

FIG. 7 is a schematic view showing a lock-off switch in a locked state in the power tool of FIG. 6;

FIG. 8 is a schematic view showing the lock-off switch in an unlocked state in the power tool of FIG. 7;

FIG. 9 is a wiring layout diagram of the power tool shown in FIG. 6;

FIG. 10 is a schematic view showing another lock-off switch in a locked state in the power tool of the present disclosure;

FIG. 11 is a schematic view showing the lock-off switch in an unlocked state in the power tool of FIG. 9; and

FIG. 12 is a schematic view of a switch trigger in the power tool shown in FIG. 6.

### BRIEF DESCRIPTION OF THE EMBODIMENTS

The present disclosure is further described in detail below in combination with the accompanying drawings and embodiments.

The terms used in the present disclosure are only for the purpose of describing specific embodiments and are not intended to limit the present disclosure. For example, the terms, such as “upper”, “lower”, “front”, “rear”, “left”, and “right”, indicate the orientation or positional relationship based on the orientation or positional relationship shown in the accompanying drawings. This is solely for the purpose of facilitating the description of the present disclosure and simplifying the description, and in no way indicate or imply that the devices or elements referred to must have a specific orientation, be constructed or operated in a specific orientation. Therefore, these terms should not be understood as a limitation on the present disclosure.

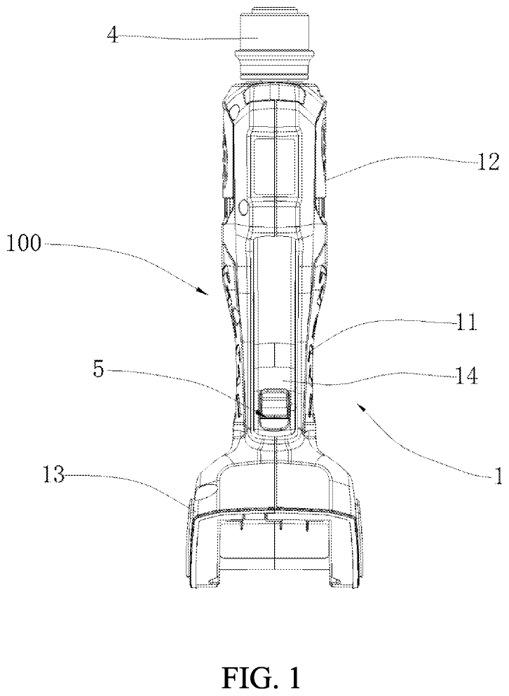

With reference to FIG. 1 to FIG. 4, embodiments of the present disclosure provide a power tool 100, specifically a polisher suitable for operations such as polishing and sanding on the surfaces of workpieces. In some embodiments, the power tool 100 is powered by a battery pack 200 which is detachably mounted to the power tool 100. The power tool 100 includes a housing 1, a motor assembly 2 mounted within the housing 1, a transmission assembly 3 coupled to a front end of the motor assembly 2, an output member 4 coupled to the transmission assembly 3, a switch assembly 5 for controlling the motor assembly 2, and a controller assembly 6 connected to the switch assembly 5. By triggering the switch assembly 5, a user initiates rotation of the motor assembly 2, and the motor assembly 2 drives the output member 4 to rotate via the transmission assembly 3. Furthermore, the housing 1 includes opposing first and second ends, with the output member 4 provided at the first end of the housing 1 and the battery pack 200 provided at the second end of the housing 1. The output member 4 is in a form of a chuck assembly. By mounting an accessory (not shown) to the chuck assembly, the tool becomes ready for operation. In some embodiments, the transmission assembly 3 is implemented as a gearbox.

In some embodiments, the transmission assembly 3 includes a planetary gear reduction mechanism 31. The transmission assembly 3 is configured to convert the high-speed and low-torque force from the motor assembly 2 into a low-speed and high-torque force to meet operational requirements.

In some embodiments, the housing 1 includes a first housing 11 configured to accommodate the motor assembly 2, a second housing 12 configured to accommodate the transmission assembly 3, and a mounting base 13 for receiving the battery pack 200. The second housing 12 and the mounting base 13 are located at the front and rear sides of the first housing 11, respectively. In other words, the first housing 11 is closer to the first end of the housing 1, and the mounting base 13 is closer to the second end of the housing 1. Furthermore, the housing 1 extends along a front-rear direction, with the output member 4, the transmission assembly 3, and the motor assembly 2 arranged in sequence within the housing 1 along this front-rear direction. In other words, the second housing 12 is disposed at the front portion, and the output member 4 extends beyond an end of the second housing 12; the first housing 11 is disposed at the middle portion and forms a handle portion 14 for the user to grip; and the mounting base 13 is disposed at the rear portion. The mounting base 13 is provided obliquely relative to an extension direction of the second housing 12 and extends in an up-down direction perpendicular to the front-rear direction.

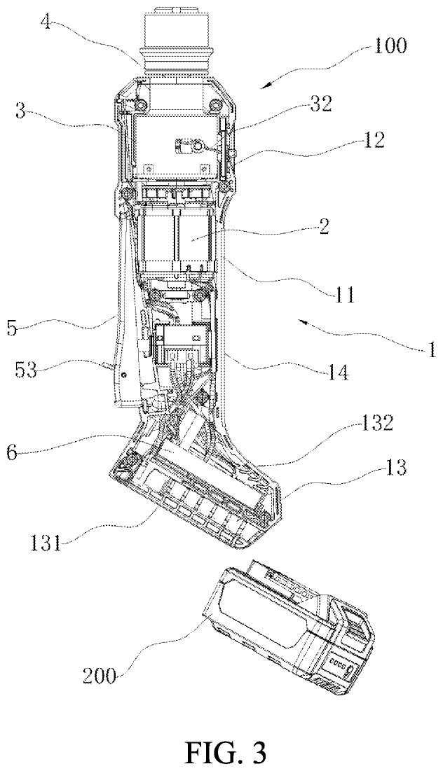

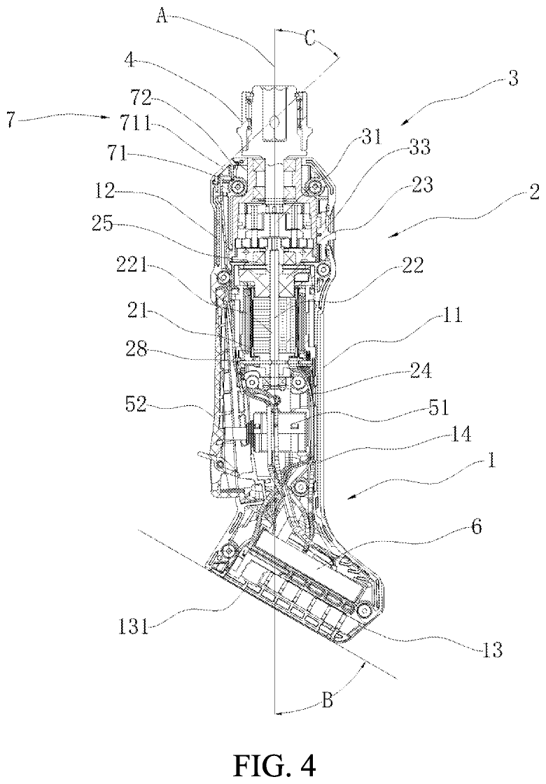

As shown in FIG. 3 and FIG. 4, an insertion slot 131 for receiving the battery pack 200 is defined on the mounting base 13, and the mounting base 13 has an inclined surface 132 that extends obliquely from the rear end of the first housing 11 relative to an axis A of the motor assembly 2. The insertion slot 131 has an opening through which the battery pack 200 is mounted into the mounting base 13 and a bottom opposing the opening, and the opening is located on a side of the insertion slot 131 away from the output member 4. The insertion slot 131 and the inclined surface 132 are located on opposing sides of the mounting base 13. An included angle B between the extension direction of the insertion slot 131 and the axis A of the motor assembly 2 is less than 90 degrees. Consequently, when the battery pack 200 is mounted to the power tool 100, the battery pack 200 is disposed in an inclined way relative to the axis A of the motor assembly 2, which reduces the space occupied by the battery pack 200 in the up-down direction. Therefore, when operating the power tool 100, the battery pack 200 is less likely to interfere with the user's arm, thereby significantly enhancing the user's experience and comfort degree. Additionally, an end surface of the mounting base 13 adjacent to the handle portion 14 is formed as the inclined surface 132 with a curved transition provided between the inclined surface 132 and the first housing 11, such that the space occupied by the mounting base 13 in the up-down direction can be reduced. This configuration also minimizes potential interference between the mounting base 13 and the user's arm, resulting in more comfortable operation and improved ergonomics.

In some embodiments, the included angle B between the extension direction of the insertion slot 131 and the axis A of the motor assembly 2 ranges from 50 degrees to 70 degrees. This configuration further reduces the space occupied by the battery pack 200 in the up-down direction. Consequently, the battery pack 200 does not interfere with the user even in extreme or confined working environments, thereby expanding the application scenarios of the power tool 100 and enhancing its adaptability and operability.

In some embodiments, the included angle B between the extension direction of the insertion slot 131 and the axis A of the motor assembly 2 is 60 degrees. This configuration positions the overall center of gravity of the power tool 100 and the battery pack 200 within the user's grip area during operation. This configuration offers high comfort degree, is favorable for long-time operation, reduces user fatigue, and improves human-machine interaction.

In some embodiments, the axis A of the motor assembly 2 extends through the transmission assembly 3 and the output member 4. In some embodiments, the centerlines of the output member 4, the transmission assembly 3, and the motor assembly 2 coincide on the same central axis. In some embodiments, the centerlines of the output member 4, the transmission assembly 3, and the motor assembly 2 all coincide with the axis A of the motor assembly 2, contributing to a more aesthetically pleasing appearance of the power tool.

In some embodiments, the diameter of the handle portion 14 is smaller than a diameter of the second housing 12, and the diameter of the handle portion 14 is in a range from 120 mm to 180 mm. This size range allows for a more comfortable grip of the user.

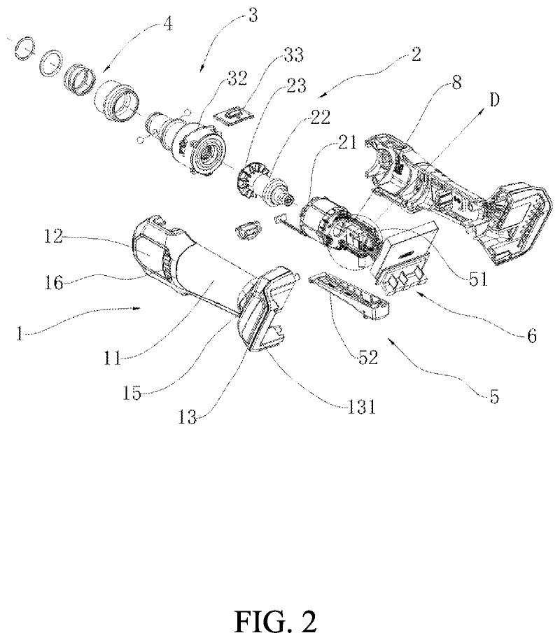

With reference to FIG. 2 and FIG. 4, the switch assembly 5 is mounted in the first housing 11. The switch assembly 5 includes a switch element 51 electrically connected to the motor assembly 2 and a switch trigger 52 for triggering the switch element 51. The switch element 51 is disposed between the controller assembly 6 and the motor assembly 2. The switch trigger 52 is at least partially exposed outside the first housing 11 for operation of the user.

In some embodiments, the switch element 51 is a main circuit switch, and the switch trigger 52 is a rod trigger. An end of the switch trigger 52 is pivotally mounted to the housing 1. The user activates the motor assembly 2 by pressing the switch trigger 52.

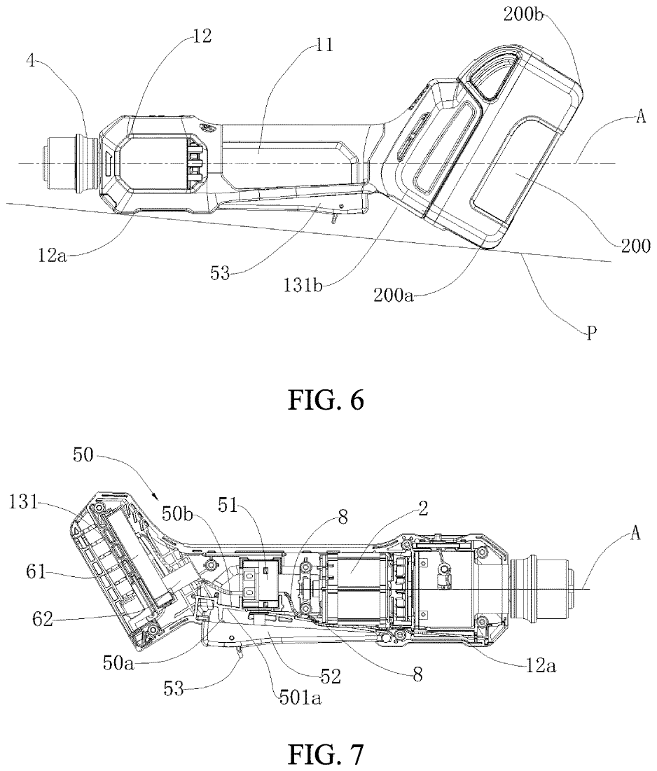

In some embodiments, the mounting base 13 is provided with a protrusion 131a extending toward the switch trigger 52. That is, the protrusion 131a constitutes the first end of the mounting base 13 and is closer to the first end of the power tool 100 compared to a distal end 131c of the mounting base, where the distal end 131c is the second end of the mounting base 13. Referring to FIG. 6, the battery pack 200 has a first end portion 200a and a second end portion 200b opposing the first end portion 200a. The first end portion 200a is adjacent to the first end 131a of the mounting base 13, and the second end portion 200b is adjacent to the second end 131c of the mounting base 13. The first end portion 200a is closer to the output member 4 than the second end portion 200b, and the first end portion 200a abuts against the protrusion 131a of the mounting base. In addition, the second housing 12 is provided with a protrusion 12a located below the transmission assembly. When the power tool 100 is equipped with the battery pack 200 and placed on a flat surface P, the first end portion 200a of the battery pack 200 and the protrusion 12a of the second housing together support the power tool 100, preventing it from tipping over. In some embodiments, an accommodation space 131b is formed between the first end 131a and the protrusion 12a. The accommodation space 131b is defined by the mounting base 13, the first housing 11, and the second housing 12, and is located below the axis A of the motor assembly 2. The switch trigger 52 is fully housed within the accommodation space 131b. Additionally, the switch assembly 5 includes a lock-off switch 53. The distance from the first end portion 200a to the axis A of the motor assembly 2 is greater than the distance from the lowest point of the lock-off switch 53 to the axis A of the motor assembly 2. This ensures that when the power tool 100 is placed on a flat surface P, the lock-off switch 53 will not come into contact with the surface, thereby preventing accidental activation.

To successfully activate the switch element 51, the user needs to first unlock by operating the lock-off switch 53. Specifically, an engagement portion 50 protrudes from the interior of the housing 1. The engagement portion 50 has an engagement surface 501 that is in contact with the lock-off switch 53. The lock-off switch 53 can slide along the engagement surface 501 to achieve unlocking.

In some embodiments, the engagement portion 50 may have the structure shown in FIG. 7. In this structure, the engagement portion 50 includes an engagement protrusion 50a and an engagement body 50b. A lower surface of the engagement body 50b forms an engagement surface 501a. When the lock-off switch 53 is not rotated, a connecting arm 532 of the lock-off switch 53 abuts against the engagement protrusion 50a. In this state, the lock-off switch 53 restricts the pivoting of the switch trigger 52. When the lock-off switch 53 is rotated, the connecting arm 532 slides along the engagement surface 501a.

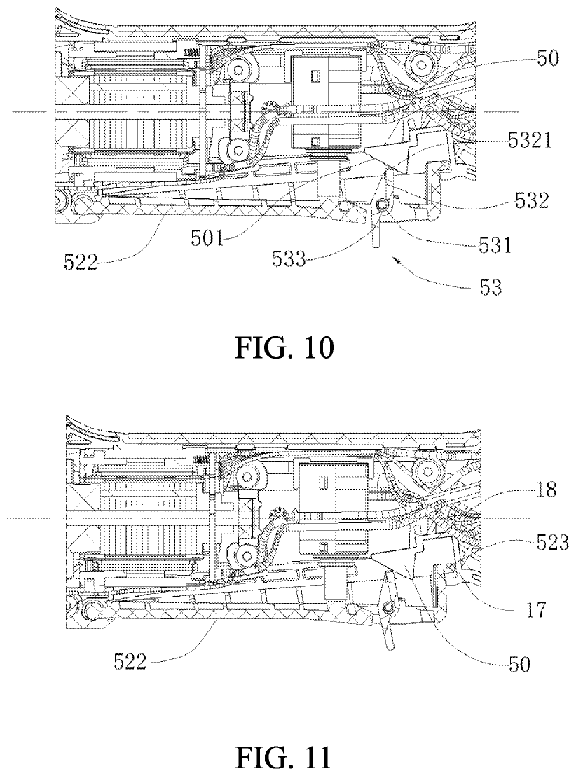

Referring to FIG. 10 and FIG. 11, the present disclosure provides another lock-off switch structure. The switch trigger 52 includes a pivot shaft 521 connected to the housing 1 and configured to pivot relative to the housing 1, and a trigger body 522 extending from the pivot shaft 521. The pivot shaft 521 is disposed near either the first end or the second end of the housing 1. The lock-off switch 53 is on a side of the trigger body 522 away from the pivot shaft 521. The trigger body 522 is provided with a through opening 5221, and the lock-off switch 53 is at least partially received and movable within the opening 5221.

The lock-off switch 53 includes a pivot shaft 531, a connecting arm 532 extending from the pivot shaft 531 toward the engagement portion 50, and an actuation portion 533 extending from the pivot shaft 531 away from the engagement portion 50. The connecting arm 532 is in contact with the engagement surface 501. The trigger body 522 is provided with a through hole 5222 on a sidewall of the opening 5221, and the pivot shaft 531 is mounted in the through hole 5222.

The unlocking process using the lock-off switch is described as follows. The lock-off switch 53 has a first position, in which movement of the switch trigger 52 relative to the switch element 51 is restricted, and a second position, in which the movement of the switch trigger 52 relative to the switch element 51 is free. In other words, the connecting arm 532 is in contact with the engagement surface 501 at a contact point 5321 and slides thereon. In the first position, due to the support force exerted by the engagement surface 501 on the connecting arm 532, the switch trigger 52 cannot be pressed down. In this position, the line connecting the contact point 5321 and the center of the pivot shaft 531 forms an included angle of 90 degrees with the engagement surface 501. When the connecting arm 532 slides to the second position, the switch trigger 52 can be pressed down to activate the switch element 51. In this position, the line connecting the contact point 5321 and the center of the pivot shaft 531 forms an included angle of 75 degrees with the engagement surface 501. This indicates that as the connecting arm 532 slides from the first position to the second position, the included angle formed between the line connecting the contact point 5321 and the center of the pivot shaft 531 and the engagement surface 501 decreases from 90 degrees to 75 degrees. Through this sliding actuation mechanism, the lock-off switch 53 would not be jammed by the housing 1, thereby allowing the switch trigger 52 to be fully pressed without requiring a secondary operation by the user.

In some embodiments, the engagement portion 50 may have a completely triangular cross-section. This structure ensures continuous contact between the lock-off switch 53 and the engagement surface 501 throughout the operation of the lock-off switch, thereby providing a better user experience.

In some embodiments, the switch trigger 52 includes a latching portion 523 that extends from an end of the trigger body 522 away from the pivot shaft 521. The housing 1 is provided with a latching arm 17 configured to engage with the latching portion 523, and a dust shield 18 connecting the engagement portion 50 to the latching arm 17. The engagement portion 50, the latching arm 17, and the dust shield 18 are integrally formed as a single piece. In some embodiments, at least a portion of the engagement portion 50 extends between the lock-off switch 53 and the latching portion 523, allowing the lock-off switch 53 and the engagement portion 50 to come into contact. In some embodiments, the dust shield 18 defines a space for the latching portion 523 to move, thereby ensuring the normal operation of the switch trigger 52. Additionally, the engagement between the latching portion 523 and the latching arm 17 and the arrangement of the dust shield 18 can effectively prevent external dust from entering the interior of the housing.

In some embodiments, the controller assembly 6 is housed in the mounting base 13 and is arranged at an angle relative to the axis A of the motor assembly 2. The axis A of the motor assembly 2 passes through the controller assembly 6.

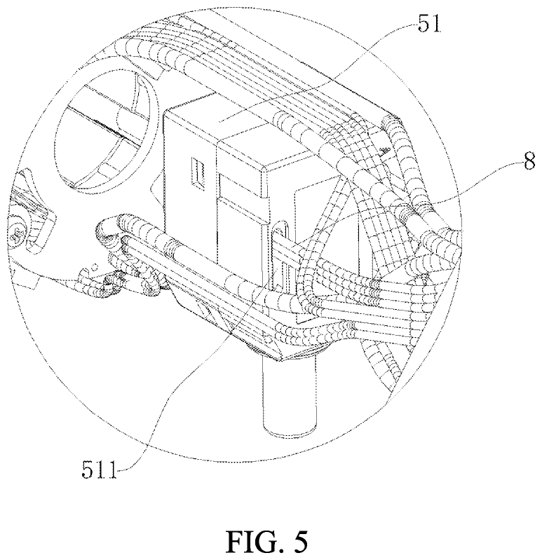

As shown in FIG. 2 and FIG. 5, the power tool 100 includes wires 8 connecting the motor assembly 2 and the switch assembly 5 to the controller assembly 6. The switch element 51 is provided with a through wiring channel 511, and at least a portion of the wires 8 are routed through the wiring channel 511. Given the relatively large number of the wires 8, the wiring channel 511 contributes to a cleaner wiring layout of the wires 8 and facilitates the wiring process.

Referring to FIG. 2 and FIG. 4, the motor assembly 2 includes a stator 21 and a rotor 22 connected to each other, a fan 23 driven by the rotor 22, and a first bearing 24 and a second bearing 25 supporting at front and rear sides of a rotor shaft 221 of the rotor 22. The first bearing 24 is disposed within the first housing 11, and the second bearing 25 is disposed within the second housing 12.

Furthermore, the stator 21 and the fan 23 are disposed between the first bearing 24 and the second bearing 25. The rotor shaft 221 extends into the second housing 12 and is coupled to the transmission assembly 3.

In some embodiments, the fan 23 is disposed between the stator 21 and the transmission assembly 3. An air inlet 15 and an air outlet 16 are defined on the housing 1. The air inlet 15 is defined on the mounting base 13 and adjacent to the controller assembly 6. The air outlet 16 is defined adjacent to the fan 23. The fan 23 is configured as a centrifugal fan. When the motor assembly 2 drives the output member 4 to rotate, it also drives the fan 23 to rotate at a high speed, generating a cooling airflow that enters through the air inlet 15 and exits through the air outlet 16. The cooling airflow sequentially passes over the controller assembly 6, the switch assembly 5, and the motor assembly 2, thereby providing efficient cooling for the controller assembly 6, the switch assembly 5, and the motor assembly 2.

In some embodiments, the motor assembly 2 is a brushless DC motor. The motor assembly 2 further includes a Hall board 28 fixed to the stator 21 using screws, and the Hall board 28 is electrically connected to the controller assembly 6.

As shown in FIG. 2 to FIG. 4, the transmission assembly 3 includes a gear shift wire 32 connected to the planetary gear reduction mechanism 31 and a gear shifter 33 for moving the gear shift wire 32. The gear shifter 33 is exposed outside the second housing 12 for operation of the user and is configured to change a transmission ratio of the planetary gear reduction mechanism 31. To avoid interfering with the user's operation on the switch trigger 52, the gear shifter 33 and the switch trigger 52 are disposed on opposing upper and lower sides of the transmission assembly 3.

In some embodiments, the transmission assembly 3 may be switchable between two gear stages: a high-speed gear (first gear stage) and a low-speed gear (second gear stage). In the high-speed gear, the power tool 100 is used for sanding operations, with a transmission ratio of 1:5 and an output rotational speed ranging from 2,700 to 3,300 revolutions per minute (RPM). In the low-speed gear, the power tool 100 is used for drilling operations, with a transmission ratio of 1:15 and an output rotational speed ranging from 900 to 1,100 RPM.

In some embodiments, in the high-speed gear, the output rotational speed of the power tool 100 is 3,000 RPM; and in the low-speed gear, the output rotational speed of the power tool 100 is 1,000 RPM.

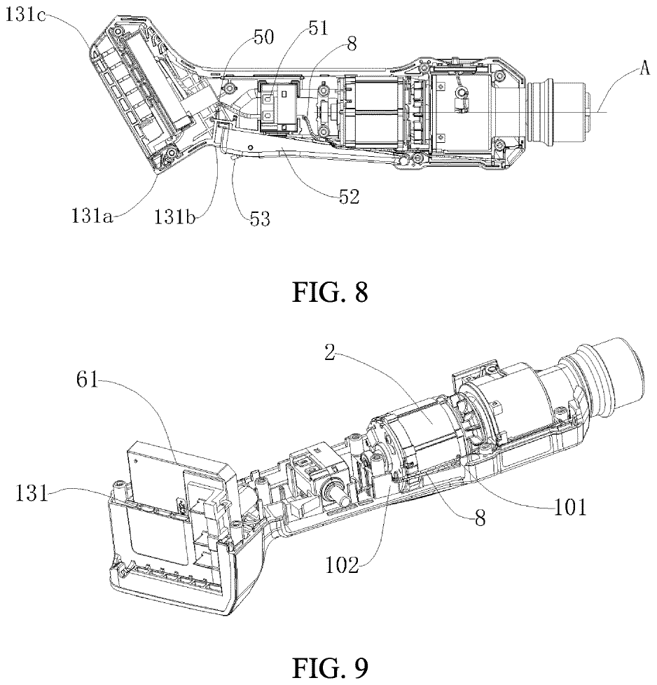

As shown in FIG. 4, FIGS. 7-9, and FIG. 12, the power tool 100 further includes an illumination assembly 7 mounted at a front end of the second housing 12. That is, the illumination assembly 7 is disposed at the first end of the housing 1 and adjacent to the output member 4. The illumination assembly 7 is connected to the controller assembly 6 via wires 8. The motor assembly 2 is disposed between the illumination assembly 7 and the controller assembly 6. In other words, the wires 8 extend from the illumination assembly 7, pass through the motor assembly 2 and the switch assembly 5, and are connected to the controller assembly 6.

The routing of the wires for the illumination assembly 7 is described as follows. The wires 8 leading from the illumination assembly 7 first extend between the transmission assembly 3 and an inner wall of the housing 1. In this area, the gear shifter 33 and the wires 8 are disposed on opposing sides of the transmission assembly 3. Subsequently, because the trigger body 522 is disposed between the controller assembly 6 and the illumination assembly 7, and both the illumination assembly 7 and the trigger body 522 are disposed on the same side of the axis A of the motor assembly 2, the wires 8 need to extend between the motor assembly 2 and the trigger body 522.

In some embodiments, the wires 8 at the motor assembly 2 are held in a first wire receiving groove 101 and a second wire receiving groove 102 defined on opposing sides of the motor assembly 2. The first wire receiving groove 101 is defined adjacent to the pivot shaft 521, and the second wire receiving groove 102 is defined between the motor assembly 2 and the switch element 51. When the switch trigger 52 is not pressed down, the wires 8 are held in place and will not sag under the restraint of the first wire receiving groove 101 and the second wire receiving groove 102.

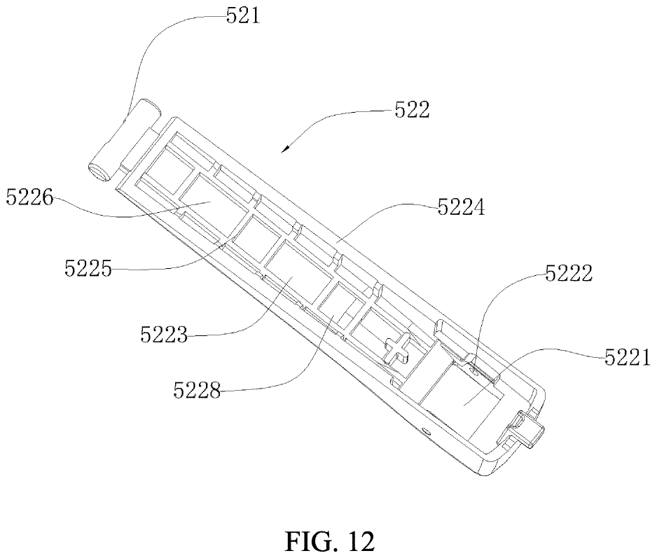

Referring to FIG. 12, the trigger body 522 includes a bottom wall 5223 for operation of the user, a pair of opposing side walls 5224 extending from the bottom wall 5223 towards the motor assembly 2, and a clearance space 5228 defined by the bottom wall 5223 and the pair of side walls 5224. When the switch trigger 52 is pressed down, at least a portion of the wires 8 are received within the clearance space 5228, effectively preventing the switch trigger 52 from damaging the wires 8. Additionally, the trigger body 522 includes reinforcement ribs 5225 protruding from the bottom wall 5223 and wire-relief slots 5226 defined by the reinforcement ribs 5225. The wire-relief slots 5226 are in communication with the clearance space 5228, and can further enlarge the accommodation space for the wires 8.

When extending out of the motor assembly 2, the wires 8 pass through the switch element 51. In this case, a portion of the wires 8 are routed along a side of the switch element 51. This arrangement prevents an actuation button on the lower side of the switch element from damaging the wires.

In some embodiments, the illumination assembly 7 includes a light 71 connected to the controller assembly 6 and a light cover 72 for shielding the light 71. The light 71 is powered by the battery pack 200 and is configured to illuminate the work area in dimly lit environments. The light cover 72 is mounted at the front end of the second housing 12 and has a light-guiding surface 711 through which light from the light 71 passes. An included angle C between the light-guiding surface 711 and the axis A of the motor assembly 2 ranges from 35 to 60 degrees, allowing better lighting effect of the illumination assembly 7.

In some embodiments, the included angle C between the light-guiding surface 711 and the axis A of the motor assembly 2 ranges from 40 to 60 degrees.

In some embodiments, when extending out of the switch element 51, the wires 8 are ultimately connected to the controller assembly 6. The controller assembly 6 includes a controller board 61 and a capacitor 62 electrically connected to the controller board 61. The controller board 61 and the motor assembly 2 are disposed on opposing sides of the handle portion 14. The controller board 61 is configured to send control commands for the operation of the motor assembly 2, and the capacitor 62 is configured to smooth and stabilizes the DC power output, thereby reducing the impact of alternating impulse currents on the electronic circuit. The axis A of the motor assembly 2 passes through the controller board 61 and the capacitor 62. The controller board 61 is disposed in an inclined way relative to the axis A of the motor assembly 2. Since the battery pack 200 is mounted to the mounting base 13 via the insertion slot 131, to ensure the compactness of the housing 1 in the up-down direction, the insertion slot 131 is preferably in parallel with the extension direction of the controller board 61.

Additionally, as the wires 8 pass by the capacitor 62 when connected to the controller board 61, to minimize interference from the capacitor 62 on the wires 8, the capacitor 62 may be disposed perpendicular to the controller board 61 and may protrude into the first housing 11. In this configuration, the capacitor 62 is oriented at an included angle ranged from 20 to 40 degrees, preferably 30 degrees, relative to the axis A of the motor assembly 2.

An included angle between an extension direction of the insertion slot 131 and the axis A of the motor assembly 2 less than 90 degrees allows the battery pack 200 to be mounted in an inclined way relative to the axis of the motor assembly 2 when the battery pack 200 is mounted to the power tool 100. Thus, the space occupied by the battery pack 200 in the up-down direction can be reduced. Therefore, when operating the power tool 100, the battery pack 200 is less likely to interfere with the user's arm, thereby significantly enhancing the user's experience and comfort degree. Furthermore, a surface of the mounting base 13 adjacent to the handle portion 14 is formed as an inclined surface 132 relative to the axis of the motor assembly, which reduces the space occupied by the mounting base in the up-down direction. This configuration also decreases the likelihood of the interference of the mounting base 13 with the user's arm, making operation more comfortable and enhancing ergonomic compatibility. The switch element 51 is provided with a through wiring channel 511, through which at least a portion of the wires 8 are routed. Given the relatively large number of the wires 8, the wiring channel 511 contributes to a cleaner wiring layout of the wires 8 and facilitates the wiring process. Additionally, the included angle C between the light-guiding surface 711 and the axis A of the motor assembly 2 ranges from 35 to 60 degrees, which optimizes the lighting effect of the illumination assembly 7.

In some embodiments, the power tool 100 according to the present disclosure may be used for tire repair, particularly for sanding the inner surface of a tire. The inner surface of the tire is cylindrical in shape. When the power tool 100 is used to sand the inner surface of the tire, the axis A of the motor assembly 2 and the tire define a chord. During the tire repair process with the power tool 100, the axis A of the motor assembly 2 remains parallel to this chord. Furthermore, inserting the battery pack 200 into the mounting base 13 in an inclined way relative to the axis A of the motor assembly 2 helps minimize contact between the battery pack 200 and the inner surface of the tire during the tire repair operation with the power tool 100.

The present disclosure is not limited to the specific embodiments described above. Those skilled in the art will readily appreciate that there are many alternatives to the power tool of the present disclosure without departing from its principles and scope. The scope of protection of the present disclosure is defined by the appended claims.

What is claimed is

1. A power tool, comprising:
a housing, a motor assembly mounted within the housing, a switch assembly for controlling the motor assembly, a transmission assembly coupled to the motor assembly, and an output member coupled to the transmission assembly;
wherein the motor assembly is configured to drive the output member to rotate, and the housing includes a first housing configured to accommodate the motor assembly, a second housing configured to accommodate the transmission assembly, and a mounting base configured to receive a battery pack;
wherein the first housing has a handle portion for a user to hold, the second housing is located at a front end of the first housing, and the mounting base is located at a rear end of the first housing; and
wherein the mounting base is provided with an insertion slot, the insertion slot has an opening through which the battery pack is mounted into the mounting base and a bottom opposing the opening, the opening is located on a side of the insertion slot away from the output member, and an extension direction of the insertion slot is inclined at an angle of less than 90 degrees relative to an axis of the motor assembly.

2. The power tool according to claim 1, wherein the switch assembly includes a switch element electrically connected to the motor assembly and a switch trigger for actuating the switch element, the mounting base has a first end and a second end opposing the first end, the first end is closer to the output member than the second end, and the second housing is provided with a protrusion adjacent to the switch trigger, and wherein the first end and the protrusion together define an accommodation space for accommodating the switch trigger.

3. The power tool according to claim 1, wherein the mounting base has an inclined surface that is inclined relative to the axis of the motor assembly, and a curved transition is provided between the inclined surface and the first housing.

4. The power tool according to claim 1, wherein the motor assembly is coaxial with the output member and the transmission assembly.

5. The power tool according to claim 1, wherein the angle included between the insertion slot and the axis of the motor assembly ranges from 50 degrees to 70 degrees.

6. The power tool according to claim 1, wherein a diameter of the handle portion is smaller than a diameter of the second housing, and the switch assembly is mounted in the first housing.

7. The power tool according to claim 6, wherein the diameter of the handle portion ranges from 120 mm to 180 mm.

8. The power tool according to claim 2, wherein the power tool includes a controller assembly connected to the switch assembly, the switch element of the switch assembly is disposed between the controller assembly and the motor assembly, the controller assembly is housed in the mounting base, and the controller assembly includes a controller board that is inclined relative to the axis of the motor assembly.

9. The power tool according to claim 8, wherein the power tool includes wires connecting the motor assembly, the switch assembly, and the controller assembly to each other, a wiring channel is defined on the switch element, and at least a portion of the wires are routed through the wiring channel.

10. The power tool according to claim 9, wherein the motor assembly includes a stator and a rotor connected to each other, and a fan driven by the rotor, wherein the fan is disposed between the stator and the transmission assembly, the housing is provided with an air inlet and an air outlet, wherein the air inlet is defined adjacent to the controller assembly and the air outlet is defined adjacent to the fan, and the fan is a centrifugal fan.

11. The power tool according to claim 10, wherein the motor assembly includes a first bearing and a second bearing supporting on two sides of a rotor shaft of the rotor, the stator and the fan are disposed between the first bearing and the second bearing, and the rotor shaft extends into the second housing; and
wherein the first bearing is disposed in the first housing, and the second bearing is disposed in the second housing.

12. The power tool according to claim 1, wherein the power tool has a first gear stage and a second gear stage, wherein in the first gear stage, a transmission ratio of the power tool is 1:5, and in the second gear stage, the transmission ratio of the power tool is 1:15.

13. The power tool according to claim 12, wherein in the first gear stage, an output rotational speed of the power tool ranges from 2700 r/min to 3300 r/min, and in the second gear stage, the output rotational speed of the power tool ranges from 900 r/min to 1100 r/min.

14. A power tool, comprising:
a housing, a motor assembly mounted within the housing, a gearbox coupled to a front end of the motor assembly, a controller assembly coupled to a rear end of the motor assembly, and an output member driven by the gearbox;
wherein the motor assembly has an axis passing through the controller assembly, the gearbox, and the output member, the housing includes a first housing configured to accommodate the motor assembly, a second housing configured to accommodate the gearbox, and a mounting base configured to receive a battery pack, and the controller assembly is installed inside the mounting base;
wherein the mounting base is provided with an insertion slot for mounting the battery pack, and the insertion slot is inclined at an angle of less than 90 degrees relative to the axis of the motor assembly; and
wherein the housing is further provided with a gear shifter configured to shift gear stages of the power tool and a switch trigger configured to control start or stop of the motor assembly, and the gear shifter and the switch trigger are respectively disposed on opposing sides of the gearbox.

15. The power tool according to claim 14, wherein the mounting base has a first end and a second end opposing the first end, the first end is closer to the output member than the second end, and the second housing is provided with a protrusion adjacent to the switch trigger, wherein the first end and the protrusion together define an accommodation space for accommodating the switch trigger, and wherein the gear shifter is mounted to the second housing, and the switch trigger is mounted to the first housing.

16. The power tool according to claim 14, wherein the controller assembly includes a controller board that is inclined relative to the axis of the motor assembly.

17. The power tool according to claim 14, further comprising a switch assembly for controlling the motor assembly, wherein
the switch assembly includes a switch element electrically connected to the motor assembly, a switch trigger for actuating the switch element, and a lock-off switch mounted to the switch trigger, wherein the switch trigger is at least partially exposed outside the housing, and the switch trigger is a rod trigger, and wherein an end of the switch trigger is pivotally mounted to the housing, and the lock-off switch is disposed on an opposing side of the end of the switch trigger.

18. The power tool according to claim 17, wherein
the power tool includes an engagement portion configured to engage with the lock-off switch, wherein the engagement portion includes an engagement surface in contact with the lock-off switch, the lock-off switch includes a pivot shaft and a connecting arm extending from the pivot shaft toward the engagement portion, and the connecting arm is arranged to be inclined relative to the engagement surface.

19. The power tool according to claim 18, wherein
the lock-off switch has a first position in which the switch trigger is restricted from moving relative to the switch element and a second position in which the switch trigger is free to move relative to the switch element, and in the first position, an end of the lock-off switch abuts against the engagement surface.

20. The power tool according to claim 19, wherein
the lock-off switch includes an actuation portion extending from the pivot shaft away from the engagement portion, and the connecting arm is in contact with the engagement surface.
